(19) United States
(12) Patent Application Publication
(10) Pub. No.: US 2006/0227043 A1
(43) Pub. Date: Oct. 12, 2006

(54) Passive geostationary satellite position determination

(76) Inventors: FM Bay, Sunnyvale, CA (US); David E. Walton, Montgomery Village, MD (US); Daniel J. Heil, Los Gatos, CA (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/376,475

(22) Filed: Mar. 14, 2006

Related U.S. Application Data
(60) Provisional application No. 60/669,341, filed on Apr. 7, 2005.

(51) Int. Cl. G01S 3/02; H04B 7/185

(52) U.S. Cl. 342/357.01; 342/453; 342/465

(57) ABSTRACT

Systems and methods for accurately determining the position of a satellite such as, for example, a geostationary satellite. In one embodiment, a satellite position determination system (10) includes an uplink station (20), a transceiver (50) onboard the satellite (12), a plurality of receiver stations (30A-30D), and a master station (40). A time stamped message included in an uplink signal (80) is transmitted from the uplink station (20), received by the transceiver (50), and rebroadcast without modification in a ubiquitous regional broadcast signal (90) from the transceiver (50). The message is received by the receiver stations (30A-30D) from the signal (90) and is retransmitted from each receiver station (30A-30D) via dedicated communication links (70A-70D) to the master station (40). The master station (40) determines the three-dimensional position of the satellite based on time differentials of arrival in the retransmitted rebroadcast messages.

### RELATED APPLICATION INFORMATION

This application claims priority from U.S. Provisional Application Ser. No. 60/669,341 entitled “PASSIVE GEOSTATIONARY SATELLITE POSITION DETERMINATION” filed on Apr. 7, 2005, the entire disclosure of which is incorporated by reference herein.

### FIELD OF THE INVENTION

The present invention relates generally to the determining the position of a satellite, and more particularly to the determination of the position of a satellite using passive techniques.

### BACKGROUND OF THE INVENTION

Space-based augmentation systems (SBAS) employing geostationary satellites in geosynchronous orbit around the earth are utilized to improve performance of properly capable Global Positioning System (GPS) devices. In this regard, SBAS often employ differential GPS techniques in order to identify errors in GPS signals and generate correction information that is broadcast by the SBAS to augment conventional GPS signals in order to enhance position determinations made by GPS devices receiving GPS signals in conjunction with the correction information.

Typical space-based augmentation systems (SBAS) do not include an accurate GPS-type ranging message in the space-based broadcast. Use of the current SBAS ranging signal improves availability of ranging signals, but results in degraded positional accuracy for the SBAS user. This is primarily due to a lack of sufficiently accurate knowledge of the position of the geostationary satellite.

The conventional implementation of the SBAS ranging signal uses the SBAS monitoring network and a satellite ephemeris prediction algorithm as the basis of the satellite position determination. Since for most SBAS applications (especially those targeted by the existing implementations), the SBAS ranging signal is non-critical and such implementation is acceptable. However, many non-SBAS applications, including ground-based augmentation systems (GBAS) and aircraft-based augmentation systems (ABAS), would be better served with a more accurate SBAS ranging signal based on more accurate knowledge of the SBAS satellite location.

### SUMMARY OF THE INVENTION

Accordingly, the present invention provides for accurate determination of the three-dimensional position of a satellite. In this regard, the satellite may, for example, be a geostationary satellite in geosynchronous orbit having a SBAS payload onboard. In accordance with the present invention, the position of the satellite is determined based on differences in arrival times at a master station of a time stamped message that is uplinked from the master station to the satellite, rebroadcast to a number of geographically diverse receiver stations, and retransmitted from the receiver stations to the master station. The present invention employs a passive technique since it does not rely on a radar signal or the like that is reflected from the satellite and especially since the message normally broadcast by the SBAS is time stamped. The present invention provides for determination of the satellite's position to the level of GPS satellites and makes the SBAS ranging information suitable for non-SBAS applications. Further, the present invention does not require any changes to the existing SBAS architectures or implementations unless the SBAS implementations take advantage of the improved satellite position information.

According to one aspect of the present invention, a method of determining a three-dimensional position of a satellite is provided. The satellite may, for example, be in a geosynchronous orbit. The method includes the step of transmitting a time stamped message from an initial ground location. The time stamped message is received at the satellite, and the time stamped message is rebroadcast from the satellite without modifying the message. The rebroadcast time stamped message from the satellite is received at a plurality of intermediary ground locations and is retransmitted from each of the intermediary ground locations to an end ground location. In this regard, the rebroadcast time stamped message may be retransmitted from the intermediary locations to the end locations via dedicated communication links. After receiving the retransmitted rebroadcast time stamped messages at the end location, the three-dimensional position of the satellite is determined based on time differentials of arrival at the end ground location among the retransmitted rebroadcast time stamped messages received from the intermediary ground locations. By repeating the step of transmitting a time stamped message from an initial ground location at, for example, regular epochs, and also other steps of the method, the position of the satellite may be periodically determined.

In order to determine the position of the satellite without requiring synchronized clocks at the initial, intermediary, and end ground locations, there should be at least four different intermediary ground locations at which the rebroadcast time stamped message is received from the satellite. In one embodiment, the initial ground location coincides with the end ground location. In other embodiments, the initial ground location may differ from the end ground location. In this regard, the initial ground location may, for example, coincide with one of the intermediary ground locations, or the end ground location may, for example, coincide with one of the intermediary ground locations.

Regardless of the number of intermediary ground locations and whether the initial and/or end locations coincide with one another or with any of the intermediary locations, the three-dimensional positions (e.g., latitude, longitude, and elevation) of the initial, intermediary, and end locations should be known within acceptable levels of certainty. In this regard, the method may include surveying the initial, intermediary and end ground locations to fix their three-dimensional positions. The acceptable level of certainty with which the initial, intermediary, and end ground locations should be surveyed is not necessarily fixed, but it may be desirable to survey the various ground locations with precision sufficient to achieve improvements over conventional satellite location methodologies. For example, the latitude, longitude and elevation of the initial, intermediary, and end ground locations may be precision surveyed within current GPS survey accuracy levels.

According to another aspect of the present invention, a system operable to determine a three-dimensional position of a satellite is provided. The satellite may, for example, be in a geosynchronous orbit. The system includes an uplink station at a known ground location, a transceiver onboard the satellite, a plurality of receiver stations at known ground locations, and a master station at a known ground location. In this regard, the positions of the initial, intermediary, arid end ground locations need not necessarily be known with a fixed level of certainty, but it is desirable that their locations be known with precision sufficient to achieve improvements over conventional satellite location methodologies. For example, the latitude, longitude and elevation of the initial, intermediary, and end ground locations may be known within current GPS survey accuracy levels.

The uplink station is operable to transmit a time stamped message therefrom. In this regard, the uplink station may be operable to transmit a time stamped message therefrom at, for example, regular epochs, in order to permit periodic determination of the position of the satellite. The transceiver onboard the satellite is operable to receive the time stamped message from the uplink station. The transceiver is further operable to rebroadcast the time stamped message from the satellite without modifying the message. Each of the receiver stations is operable to receive the rebroadcast time stamped message from the satellite. Each receiver station is also operable to retransmit the rebroadcast time stamped message. In this regard, the system may include a plurality of dedicated communication links, with each dedicated communication link communicating the retransmitted rebroadcast time stamped message directly from an associated one of the receiver stations to the master station.

The master station is operable to receive the retransmitted rebroadcast time stamped messages from each of the receiver stations. The master station is also operable to determine the three-dimensional position of the satellite by reconciling time differentials of arrival at the master station among the retransmitted rebroadcast time stamped messages.

In order to permit determination of the position of the satellite by the master station without requiring synchronized clocks at the uplink, receiver and master stations, there should be at least four receiver stations located at four different known ground locations. In one embodiment, the location of the uplink station coincides with the location of the master station. In other embodiments, the uplink station and the master station may be located at different locations. For example, the location of the uplink station may coincide with the location of one of the receiver stations, or the location of the master station may coincide with the location of one of the receiver stations.

These and other aspects and advantages of the present invention will be apparent upon review of the following Detailed Description when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1 illustrates one embodiment of a satellite position determination system in accordance with the present invention;

FIG. 2 illustrates another embodiment of a satellite position determination system in accordance with the present invention; and

FIG. 3 illustrates the steps of one embodiment of a satellite position determination method in accordance with the present invention.

### DETAILED DESCRIPTION

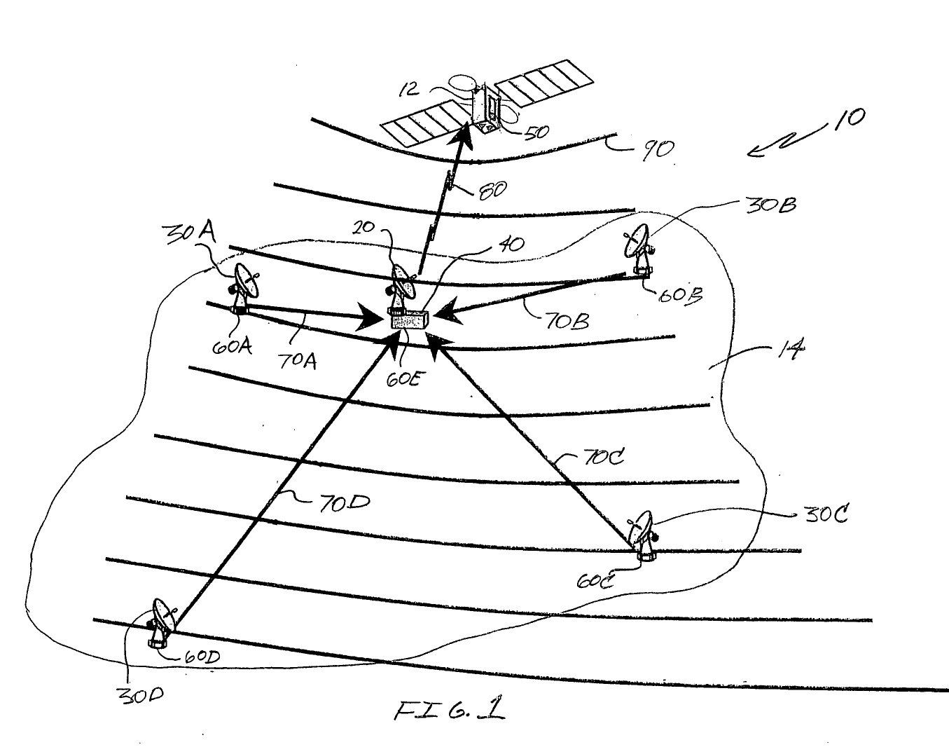

FIG. 1 shows one embodiment of a satellite position determination system 10 that operates to determine a three-dimensional position of a satellite 12. In the illustrated embodiment, the satellite 12 is in earth orbit, although it is possible that the satellite 12 may not be orbiting the earth. Further, the satellite 12 is in a geosynchronous orbit, although it is possible that the satellite may be in a non-geosynchronous orbit. Regardless of its orbit, the satellite position determination system 10 is configured to accurately determine the three-dimensional position of the satellite 12 relative to a fixed reference point (e.g., a location on the surface of the earth). In this regard, the system 10 may determine the position of the satellite 12 in accordance with a number of coordinate systems including, for example, a Cartesian coordinate system.

The system 10 includes a ground uplink station 20, four receiver stations 30A-30D, a master station 40, and a transceiver unit 50. The transceiver unit 50 is located onboard the satellite 12. The four receiver stations 30A-30D are located at four different ground locations 60A-60D on the surface of the earth 14. Each of the four ground locations 60A-60D are precision surveyed. In this regard, the latitude, longitude, and altitude of each location 60A-60D may be known to current GPS survey accuracies. The four locations 60A-60D are dispersed over a relatively large region of the earth's surface 14 wherein the satellite 12 is simultaneously in view of each ground location 60A-60D. For example, depending upon factors such as the altitude of the satellite 12, the region on the earth's surface 14 over which the four ground locations 60A-60D may encompass 120 degrees of latitude and longitude. Having at least four receiver stations 30A-30D located at four precision surveyed locations 60A-60D means that the receiver stations 30A-30D need not include synchronized clocks.

In the illustrated embodiment, the ground uplink station 20 and the master station 40 are located at a fifth ground location 60E. The fifth ground location 60E may also be precision surveyed (e.g., latitude, longitude, and altitude known to current GPS survey accuracies). Each of the receiver stations 30A-30D communicates with the master station 40 via a dedicated communication link 70A-70D. In this regard, the dedicated communication links 70A-70D may, for example, be optical communication links (e.g., fiber or over-the-air), microwave communication links, or electrically conductive wire (e.g., copper wire) communication links. Dedicated fiber-optic or microwave communication links are desirable due to their limited susceptibility to having their transit times affected by thermal changes.

The master station 40 communicates with the transceiver unit 50 onboard the satellite 12 via the ground uplink station 20. In this regard, the ground uplink station 20 transmits an uplink signal 80 that is received by the transceiver unit 50. The transceiver unit 50 onboard the satellite 12 transmits a ubiquitous regional broadcast signal 90 that is received by each of the receiver stations 30A-30D since they are in view of the satellite 12. In this regard, the ubiquitous regional broadcast signal 90 may be transmitted on two frequencies in order to permit determination of atmospheric condition induced delays in the transit of the ubiquitous regional broadcast signal 90 from the satellite 12 to each receiver station 30A-30D. Such atmospheric condition induced delays include delays due to ionospheric effects as well as delays due to atmospheric temperature differences.

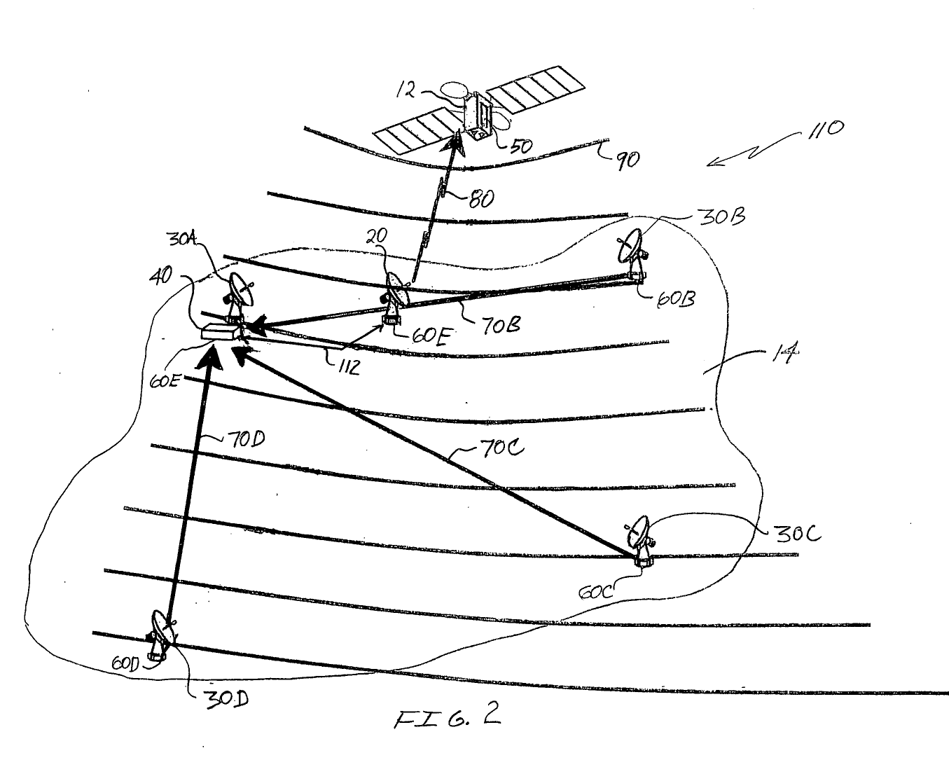

Referring to FIG. 2, in other embodiments, the ground uplink station 20 and the master station 40 may be located at different locations. For example, FIG. 2 shows an alternative embodiment of a satellite position determination system 110 in which one of the receiver stations 30A and the master station 40 may co-located at one of the four locations 60A. In this regard the ground uplink station 20 and master station 40 may communicate via a dedicated communication link 112 (e.g., optical, microwave, wired).

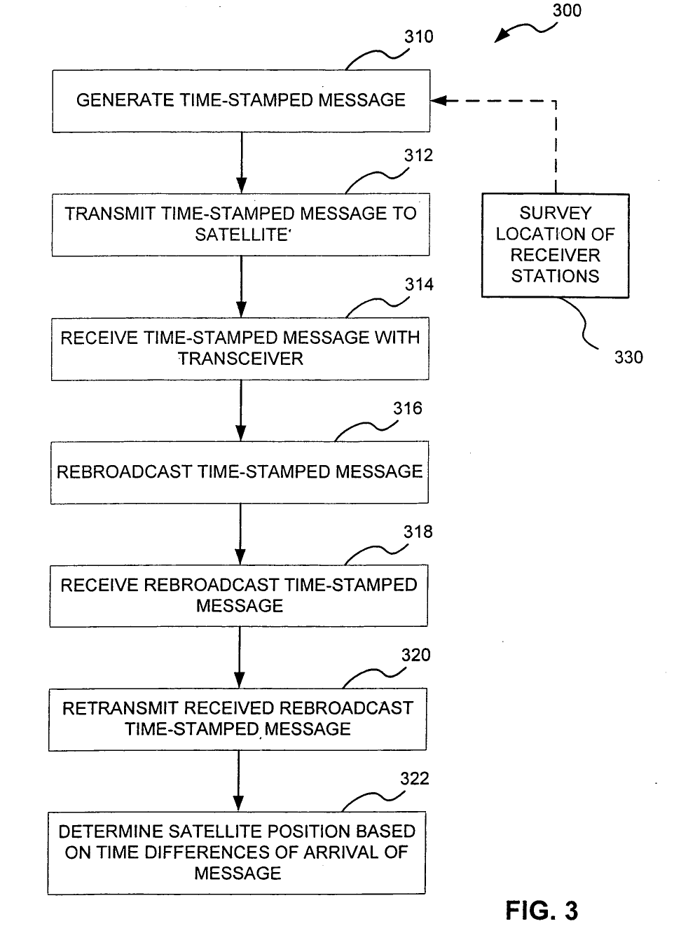

Referring to FIG. 3, there is shown one embodiment of a method (300) for determining the three-dimensional position of a satellite that may be implemented using a system 10, 110 such as shown in FIGS. 1 and 2. In step (310) of the method (300), the master station 40 generates a time stamped message. In this regard, the master station 40 may include a clock for use in generating the time stamped message.

In step (312), the time stamped message is transmitted to the satellite 12. In this regard, the ground uplink station 20 is operated to transmit the time stamped message on the uplink signal 80. Where the master station 40 is located remote from the ground uplink station 20 such as in FIG. 2, the time stamped message may initially be transmitted via dedicated communication link 112 from the master station 40 to the ground uplink station 20.

In step (314), the transceiver unit 50 onboard the satellite 12 receives the time stamped message from the uplink signal 80. In step (316), the transceiver unit 50 rebroadcasts the time stamped message using on the ubiquitous regional broadcast signal 90. In step (316), the time stamped message is rebroadcast by the transceiver unit 50 without altering the time stamped message. In this regard, the information regarding the time at which the time stamped message was generated by the master station 40 is not altered. Additionally, in step (316), the transceiver unit 50 may transmit the ubiquitous regional broadcast signal 90 on two different frequencies in order to permit subsequent determination of atmospheric induced delays.

In step (318), the rebroadcast time stamped message is received from the ubiquitous regional broadcast signal 90 by each of the receiver stations 30A-30D. In this regard, the ubiquitous regional broadcast signal may be received on both frequencies by each of the receiver stations 30A-30D.

In step (320), the received rebroadcast time stamped message is then retransmitted by each receiver station 30A-30D to the master station 40 via the dedicated communication links 60A-60D. In this regard, each retransmitted received rebroadcast time stamped message from the receiver stations 30A-30D will generally arrive at the master station 40 at different times since the distances from the satellite 12 to each receiver station 30A-30D and from each receiver station 30A-30D to the master station 40 are generally different. Where the ubiquitous broadcast signal 90 is transmitted on two frequencies, the retransmitted rebroadcast time stamped message may arrive twice at slightly different times from one or more of the receiver stations 30A-30D depending upon the presence of atmospheric condition induced delays. If so, the master station 40 may apply appropriate compensation to the arrival times of the time stamped messages from such receiver stations 30A-30D to obtain an appropriate arrival time for use in subsequent calculations.

In step (322), the three-dimensional position of the satellite 12 is determined based on the time differences in the arrival of the retransmitted rebroadcast time stamped messages from each receiver station 30A-30D at the master station 40. In order to determine the three-dimensional position of the satellite 12 from the time differences in arrival at the master station 40 of the retransmitted received rebroadcast time stamped messages, the location 60A-60D of each receiver station 30A-30D must be precisely known. In this regard, the method (300) may include an initial step (330) wherein the location of each receiver station 30A-30D is precisely surveyed. Such precision surveying may be accomplished using commercial-grade GPS surveying equipment. Step (330) may be performed from time-to-time in order to ensure that the locations 60A-60D of each receiver station 30A-30D remain accurate.

In step (322), techniques similar to those disclosed in U.S. Pat. No. 6,950,537 entitled “LOCAL WIRELESS DIGITAL TRACKING NETWORK”, the entire disclosure of which is incorporated by reference herein, may be employed to determine the three-dimensional position of the satellite 12. More particularly, in step (322) since the locations of the four receiver stations 30A-30D and the master station 40 are known, the distances of the dedicated communication links 70A-70D there between are also known, assuming the most direct path is taken by the dedicated communications links 70A-70D. However, if one or more of the dedicated communication links 70A-70D takes an indirect path between its associated receiver stations 30A-30D and the master station 40, the distance of such indirect path may be measured. Since the distances traversed by the retransmitted received rebroadcast time stamped messages via the dedicated communication links 70A-70D are known, apparent distances from the satellite 12 to each of the receiver stations 30A-30D can be obtained based on the differences in arrival time at the master station 40 among the retransmitted received rebroadcast time stamped messages. In this regard, appropriate adjustments for atmospheric delays can be applied.

Having obtained the apparent distances from the satellite 12 to each receiver station 30A-30D, the three-dimensional position of the satellite 12 can be computed. In this regard, the three-dimensional position of the satellite 12 can, for example, be computed in accordance with the following three equations:

$$\begin{matrix}\begin{matrix}{z}_{ S} = ( ( ( ( {y}_{D} {d}_{SA}^{′} - {y}_{A} {d}_{SD}^{′} - ( ( {x}_{A} {d}_{SD}^{′} - {x}_{D} {d}_{SA}^{′} ) / ( {x}_{A} {d}_{SB}^{′} - {x}_{B} {d}_{SA}^{′} ) ) \\ {y}_{B} {d}_{SA}^{′} + ( ( {x}_{A} {d}_{SD}^{′} - {x}_{D} {d}_{SA}^{′} ) / ( {x}_{A} {d}_{SB}^{′} - {x}_{B} {d}_{SA}^{′} ) ) {y}_{A} {d}_{SB}^{′} ) / ( {y}_{C} {d}_{SA}^{′} - \\ {y}_{A} {d}_{SC}^{′} - ( ( {x}_{C} {d}_{SA}^{ ′} - {x}_{A} {d}_{SC}^{′} ) / ( {x}_{B} {d}_{SA}^{′} - {x}_{A} {d}_{SB}^{′} ) ) {y}_{B} {d}_{SA}^{′} + \\ ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {y}_{A} {d}_{SB}^{′} ) ) ) ( ( 1 / 2 {d}_{SA}^{′} {}_{}^{2}{d}{}_{SC}^{′} - \\ 1 / 2 {d}_{SC}^{′} {d}_{SC}^{′} {}_{}^{2}{d}{}_{SA}^{′} - 1 / 2 {d}_{A} {}_{}^{2}{d}{}_{SC}^{′} + 1 / 2 {d}_{C} {}_{}^{2}{d}{}_{SA}^{′} ) ) - \\ ( ( ( {y}_{D} {d}_{SA}^{′} - {y}_{A} {d}_{SD}^{′} - ( ( {x}_{A} {d}_{SD}^{′} - {x}_{D} {d}_{SA}^{′} ) / {x}_{A} {d}_{SB}^{′} - {x}_{B} {d}_{SA}^{′} ) ) {y}_{B} {d}_{SA}^{′} + \\ ( ( {x}_{A} {d}_{SD}^{′} - {x}_{D} {d}_{SA}^{′} ) / ( {x}_{A} {d}_{SB}^{′} - {x}_{B} {d}_{SA}^{′} ) ) {y}_{A} {d}_{SB}^{′} ) / {y}_{C} {d}_{SA}^{′} - {y}_{A} {d}_{SC}^{′} - \\ ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {y}_{B} {d}_{SA}^{′} + ( ( {x}_{C} {d}_{SA}^{′} - {x}_{A} {d}_{SC}^{′} ) / \\ ( {x}_{B} {d}_{SA}^{′} - {x}_{A} {d}_{SB}^{′} ) ) {y}_{A} {d}_{SB}^{′} ) ) ) ( ( 1 / 2 ( ( {x}_{C} {d}_{SA}^{′} - {x}_{A} {d}_{SC}^{′} ) / ( {x}_{B} {d}_{SA}^{′} - ) / \\ ( {x}_{B} {d}_{SA}^{′} - {x}_{A} {d}_{SB}^{′} ) ) {d}_{SA}^{′} {}_{}^{2}{d}{}_{SB}^{′} - 1 / 2 ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) \\ {d}_{SB}^{′} {}_{}^{2}{d}{}_{SA}^{′} - 1 / 2 ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {d}_{A} {}_{}^{2}{d}{}_{SB}^{′} + \\ 1 / 2 ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {d}_{B}^{2} {d}_{SA}^{′} ) ) - ( ( 1 / 2 {d}_{SA}^{′} \\ {}_{}^{2}{d}{}_{SD}^{′} - 1 / 2 {d}_{SD}^{′} {}_{}^{2}{d}{}_{SA}^{′} - 1 / 2 {d}_{A}^{2} {d}_{SD}^{′} + 1 / 2 {d}_{D}^{2} {d}_{SA}^{′} ) ) + \\ ( ( 1 / 2 ( {x}_{A} {d}_{SD}^{′} - {x}_{D} {d}_{SA}^{′} ) / ( {x}_{A} {d}_{SB}^{′} - {x}_{B} {d}_{SA}^{′} ) ) {d}_{SA}^{′} {}_{}^{2}{d}{}_{SB}^{′} - 1 / 2 \\ ( ( {x}_{A} {d}_{SD}^{′} - {x}_{D} {d}_{SA}^{′} ) / {x}_{A} {d}_{SB}^{′} - {x}_{B} {d}_{SA}^{′} ) ) {d}_{SB}^{′} {}_{}^{2}{d}{}_{SA}^{′} - \\ 1 / 2 ( ( {x}_{A} {d}_{SD}^{′} - {x}_{D} {d}_{SA}^{′} ) / ( {x}_{A} {d}_{SB}^{′} - {x}_{B} {d}_{SA}^{′} ) ) {d}_{A} {}_{}^{2}{d}{}_{SB}^{′} + 1 / 2 \\ ( ( {x}_{A} {d}_{SD}^{′} - {x}_{D} {d}_{SA}^{′} ) / {x}_{A} {d}_{SB}^{′} - {x}_{B} {d}_{SA}^{′} ) ) {d}_{B} {}_{}^{2}{d}{}_{SA}^{′} ) ) ) / \\ ( ( ( ( {y}_{D} {d}_{SA}^{′} - {y}_{A} {d}_{SD}^{′} - ( ( {x}_{A} {d}_{SD}^{′} - {x}_{D} {d}_{SA}^{′} ) / ( {x}_{A} {d}_{SB}^{′} - {x}_{B} {d}_{SA}^{′} ) ) {y}_{B} {d}_{SA}^{′} + \\ ( ( {x}_{A} {d}_{SD}^{′} - {x}_{D} {d}_{SA}^{′} ) / ( {x}_{A} {d}_{SB}^{′} - {x}_{B} {d}_{SA}^{′} ) ) {y}_{A} {d}_{SB}^{′} ) / {y}_{C} {d}_{SA}^{′} - \\ {y}_{A} {d}_{SC}^{′} - ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {y}_{B} {d}_{SA}^{′} + \\ ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {y}_{A} {d}_{SB}^{′} ) ) ) {z}_{C} {d}_{SA}^{′} - \\ ( ( ( {y}_{D} {d}_{SA}^{′} - {y}_{A} {d}_{SD}^{′} - ( ( {x}_{A} {d}_{SD}^{′} - {x}_{D} {d}_{SA}^{′} ( / ( {x}_{A} {d}_{SB}^{′} - {x}_{B} {d}_{SA}^{′} ) ) {y}_{B} {d}_{SA}^{′} + \\ ( ( {x}_{A} {d}_{SD}^{′} - {x}_{D} {d}_{SA}^{′} ) / ( {x}_{A} {d}_{SB}^{′} - {x}_{B} {d}_{SA}^{′} ) ) {y}_{A} {d}_{SB}^{′} ) / \\ ( {y}_{C} {d}_{SA}^{′} - {y}_{A} {d}_{SC}^{′} - ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {y}_{B} {d}_{SA}^{′} + \\ ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {y}_{A} {d}_{SB}^{′} ) ) ) {z}_{A} {d}_{SC}^{′} - \\ ( ( ( ( {y}_{D} {d}_{SA`}^{′} - {y}_{A} {d}_{SD}^{′} ( ( {x}_{A} {d}_{SD}^{′} - {x}_{D} {d}_{SA}^{′} ) / ( {x}_{A} {d}_{SB}^{′} - {x}_{B} {d}_{SA}^{′} ) ) {y}_{B} {d}_{SA}^{′} + \\ ( ( {x}_{A} {d}_{SD}^{′} - {x}_{D} {d}_{SA}^{′} ) / ( {x}_{A} {d}_{SB}^{′} - {x}_{B} {d}_{SA}^{′} ) ) {y}_{A} {d}_{SB}^{′} ) / \\ ( {y}_{C} {d}_{SA}^{′} - {y}_{A} {d}_{SC}^{′} - ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {y}_{B} {d}_{SA}^{′} + \\ ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {y}_{A} {d}_{SB}^{′} ) ) ) \\ ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {z}_{B} {d}_{SA}^{′} + \\ ( ( ( {y}_{D} {d}_{SA}^{′} - {y}_{A} {d}_{SD}^{′} - ( ( {x}_{A} {d}_{SD}^{′} - {x}_{D} {d}_{SA}^{′} ) / ( {x}_{A} {d}_{SB}^{′} - {x}_{B} {d}_{SA}^{′} ) ) {y}_{B} {d}_{SA}^{′} + \\ ( ( {x}_{A} {d}_{SD}^{′} - {x}_{D} {d}_{SA}^{′} ) / ( {x}_{A} {d}_{SB}^{′} - {x}_{B} {d}_{SA}^{′} ) ) {y}_{A} {d}_{SB}^{′} ) / \\ ( {y}_{C} {d}_{SA}^{′} - {y}_{A} {d}_{SC}^{′} - ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {y}_{B} {d}_{SA}^{′} + \\ ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {y}_{A} {d}_{SB}^{′} ) ) ) \\ ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {z}_{A} {d}_{SB}^{′} - {z}_{D} {d}_{SA}^{′} + {z}_{A} {d}_{SD}^{′} + \\ ( ( {x}_{A} {d}_{SD}^{′} - {x}_{D} {d}_{SA}^{′} ) / ( {x}_{A} {d}_{SB}^{′} - {x}_{B} {d}_{SA}^{′} ) ) {z}_{B} {d}_{SA}^{′} - ( ( {x}_{A} {d}_{SD}^{′} - {x}_{D} {d}_{SA}^{′} ) / \\ ( {x}_{A} {d}_{SB}^{′} - {x}_{B} {d}_{SA}^{′} ) ) {z}_{A} {d}_{SB}^{′} )\end{matrix} & ( 1 ) \\ {y}_{S} = ( ( ( 1 / 2 {d}_{SA}^{′} {}_{}^{2}{d}{}_{SC}^{′} - 1 / 2 {d}_{SC}^{′} {}_{}^{2}{d}{}_{SA}^{′} - 1 / 2 {d}_{A} {}_{}^{2}{d}{}_{SC}^{′} + 1 / 2 {d}_{C} {}_{}^{2}{d}{}_{SA}^{′} ) ) - ( ( 1 / 2 ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {d}_{SA}^{′} {}_{}^{2}{d}{}_{SB}^{′} - 1 / 2 ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {d}_{SB}^{′} {}_{}^{2}{d}{}_{SA}^{′} - 1 / 2 ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {d}_{A} {}_{}^{2}{d}{}_{SB}^{′} + 1 / 2 ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {d}_{B} {}_{}^{2}{d}{}_{SA}^{′} ) ) - {z}_{C} {z}_{S} {d}_{SA}^{′} + {z}_{A} {z}_{S} {d}_{SC}^{′} + ( ( {x}_{C} {d}_{SA}^{′} - {x}_{A} {d}_{SC}^{′} ) / ( {x}_{B} {d}_{SA}^{′} - {x}_{A} {d}_{SB}^{′ '} ) ) {z}_{B} {z}_{S} {d}_{SA}^{′} - ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {z}_{A} {z}_{S} {d}_{SB}^{′} ) / {y}_{C} {d}_{SA}^{′} - {y}_{A} {d}_{SC}^{′} ( ( {x}_{C} {d}_{SA}^{′} - {x}_{A} {d}_{SC}^{′} ) / ( {x}_{B} {d}_{SA}^{′} - {x}_{A} {d}_{SB} ) ) {y}_{B} {d}_{SA}^{′} + ( ( {x}_{C} {d}_{SA}^{′} - {x}_{A} {d}_{SC}^{′} ) / ( {x}_{B} {d}_{SA}^{′} - {x}_{A} {d}_{SB}^{′} ) ) {y}_{A} {d}_{SB}^{′} ) & ( 2 ) \\ {x}_{S} = ( 1 / 2 {d}_{SA}^{′} {}_{}^{2}{d}{}_{SB}^{′} - 1 / 2 {d}_{SB}^{′} {}_{}^{2}{d}{}_{SA}^{′} - 1 / 2 {d}_{A} {}_{}^{2}{d}{}_{SB}^{′} + 1 / 2 {d}_{B} {}_{}^{2}{d}{}_{SA}^{′} - {y}_{B} {y}_{s} {d}_{SA}^{′} + {y}_{A} {y}_{s} {d}_{SB}^{′} - {z}_{B} {z}_{S} {d}_{SA}^{′} + {z}_{A} {z}_{S} {d}_{SB}^{′} ) / ( {x}_{B} {d}_{SA}^{′} - {x}_{A} {d}_{SB}^{′} ) & ( 3 )\end{matrix}$$

Where:

z_{S}, y_{S}, x_{S} are the coordinates of satellite 12 relative to master station 40;

x_{A}, y_{A}, z_{A} are the coordinates of receiver station 30A relative to master station 40;

x_{B}, y_{B}, z_{B} are the coordinates of receiver station 30B relative to master station 40;

x_{C}, y_{C}, z_{C} are the coordinates of receiver station 30C relative to master station 40;

x_{D}, y_{D}, z_{D} are the coordinates of receiver station 30D relative to master station 40;

d_{A} is the distance from receiver station 30A to master station 40 via dedicated communication link 70A;

d_{B} is the distance from receiver station 30B to master station 40 via dedicated communication link 70B;

d_{C} is the distance from receiver station 30C to master station 40 via dedicated communication link 70C;

d_{D} is the distance from receiver station 30D to master station 40 via dedicated communication link 70D;

d′_{SA} is the apparent distance from the satellite 12 to receiver station 30A;

d′_{SB} is the apparent distance from the satellite 12 to receiver station 30B;

d′_{SC} is the apparent distance from the satellite 12 to receiver station 30C; and

d′_{SD} is the apparent distance from the satellite 12 to receiver station 30D.

Although equations (1), (2) and (3) express the three-dimensional position of the satellite 12 in Cartesian coordinates relative to the master station 40, appropriate translations can be applied in order to fix the position of the satellite 12 in other coordinate systems and/or relative to other known locations. Furthermore, equations (1), (2) and (3) represent only one possible solution for the position of the satellite 12, and other solutions may be used to compute the position of the satellite 12.

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. A method of determining a three-dimensional position of a satellite, said method comprising the steps of:
transmitting a time stamped message from an initial ground location;
receiving the time stamped message at the satellite;
rebroadcasting the time stamped message from the satellite without modifying the message;
receiving the rebroadcast time stamped message at a plurality of intermediary ground locations;
retransmitting the rebroadcast time stamped message from each of the intermediary ground locations to an end ground location; and
determining the three-dimensional position of the satellite based on time differentials of arrival at the end ground location among the retransmitted rebroadcast time stamped messages from the intermediary ground locations.

2. The method of claim 1 wherein the satellite is in a geosynchronous orbit.

3. The method of claim 1 wherein therein are at least four intermediary ground locations.

4. The method of claim 1 wherein the initial ground location coincides with the end ground location.

5. The method of claim 1 wherein the initial ground location differs from the end ground location.

6. The method of claim 1 wherein the initial ground location coincides with one of the intermediary ground locations.

7. The method of claim 1 wherein the end ground location coincides with one of the intermediary ground locations.

8. The method of claim 1 further comprising:
surveying the initial, intermediary and end ground locations to fix their three-dimensional positions.

9. The method of claim 8 wherein in said step of surveying the three-dimensional positions of the initial, intermediary and end ground locations are fixed to current GPS survey accuracies of latitude, longitude, and elevation.

10. The method of claim 1 wherein said step of transmitting a time stamped message from an initial ground location is performed at regular epochs.

11. A system operable to determine a three-dimensional position of a satellite, said system comprising:
an uplink station at a known ground location, said uplink station being operable to transmit a time stamped message therefrom;
a transceiver onboard the satellite, the transceiver being operable to receive the time stamped message from said uplink station and to rebroadcast the time stamped message from the satellite without modifying the message;
a plurality of receiver stations at known ground locations, each said receiver station being operable to receive the rebroadcast time stamped message from the satellite and to retransmit the rebroadcast time stamped message; and
a master station at a known ground location, said master station being operable to receive the retransmitted rebroadcast time stamped messages from each of the receiver stations and to determine the three-dimensional position of the satellite based on time differentials of arrival at the master station among the retransmitted rebroadcast time stamped messages.

12. The system of claim 11 wherein the satellite is in a geosynchronous orbit.

13. The system of claim 11 wherein therein are at least four receiver stations.

14. The system of claim 11 wherein the location of said uplink station coincides with the location of said master station.

15. The system of claim 11 wherein the location of said uplink station differs from the location of said master station.

16. The system of claim 11 wherein the location of said uplink station coincides with the location of one of said receiver stations.

17. The system of claim 11 wherein the location of said master station coincides with the location of one of said receiver stations.

18. The system of claim 11 wherein the locations of said uplink, receiver, and master stations are known to current GPS survey accuracies of latitude, longitude, and elevation.

19. The system of claim 11 wherein said uplink station is further operable to transmit a time stamped message therefrom at regular epochs.

20. The system of claim 11 further comprising:
a plurality of dedicated communication links, each said dedicated communication link communicating the retransmitted rebroadcast time stamped message directly from an associated one of said receiver stations to said master station.

21. A system for determining a three-dimensional position of a satellite, said system comprising:
means for transmitting a time stamped message from an initial ground location;
means for receiving the time stamped message at the satellite;
means for rebroadcasting the time stamped message from the satellite without modifying the message;
means for receiving the rebroadcast time stamped message at a plurality of intermediary ground locations;
means for retransmitting the rebroadcast time stamped message from each of the intermediary ground locations to an end ground location; and
means for determining the three-dimensional position of the satellite based on time differentials of arrival at the end ground location among the retransmitted rebroadcast time stamped messages from the intermediary ground locations.

22. The system of claim 21 wherein said means for transmitting comprise an uplink station.

23. The system of claim 21 wherein said means for receiving the time stamped message at the satellite and said means for rebroadcasting the time stamped message from the satellite comprise a transceiver onboard the satellite.

24. The system of claim 21 wherein said means for means for receiving the rebroadcast time stamped message comprise a plurality of receiver stations.

25. The system of claim 21 wherein said means for retransmitting the rebroadcast time stamped message comprise a plurality of dedicated communication links between the intermediary ground locations and the end ground location.

26. The system of claim 21 wherein said means for determining comprise a master station located at the end location.
